(19) United States
(12) Patent Application Publication
(10) Pub. No.: US 2014/0317728 A1
(43) Pub. Date: Oct. 23, 2014

(54) CLOUD KEY DEVICE FOR DATA TRANSMISSION VIA AUDIO INTERFACE

(71) Applicant: Chi-Pei WANG, Hsinchu City (TW)

(72) Inventor: Chi-Pei WANG, Hsinchu City (TW)

(21) Appl. No.: 14/150,026

(22) Filed: Jan. 8, 2014

(30) Foreign Application Priority Data
Apr. 22, 2013 (TW) 102207287

(51) Int. Cl. G06F 21/34

(52) U.S. Cl. CPC G06F 21/34
USPC 726/20

(57) ABSTRACT

A cloud key device for data transmission via an audio interface has a portable body, designed with a 3D pattern, and is provided with a data transmission end. A data storage chip is set into the portable body to store accounts and passwords. A male audio plug is protruded from the data transmission end, and is electrically connected with the data storage chip such that the stored accounts and passwords could be transmitted via said audio plug. With the cloud key device, the accounts and passwords of the users can be carried conveniently, and said audio plug allows transmission of data by connecting with the standard audio jack of computers and telecom devices, so the accounts and passwords can be directly transmitted to the computers or telecom devices, thus preventing logging by non-keying means, and realizing easier input of de counts and passwords with higher security and applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to data transmission electronics, and more particularly to an innovative one which is designed into a cloud key device for transmission of accounts, passwords and data via an audio interface.

2. Description of Related Art Including Information Disclosed Under 37 CFR 1.97 and 37 CFR 1.98.

Due to original architecture of personal computer, any software could be used to access the keying data of computers without being discovered by the users. In this aspect, keylogger or spy software is a tool to illegally steal personal accounts or passwords with such characteristics. In the past, there was a shortage of encrypted keyboards in the market, so the treasures or scores of on-line game players were often stolen, on their accounts or passwords of online banks were logged, leading to a loss of money.

Currently, multiple anti-logging encrypted products have been developed for the benefit of consumers, but some shortcomings are still observed during actual applications, roughly owing to the fact that the users have to purchase encrypted hardware (e.g. encrypted keyboard, encrypted mouse and connecting lines) or encrypted software programs for accessing the encryption functions. However, such encrypted hardware cannot be easily carried, leading to greater limitations. Moreover, the input procedures for accounts and passwords could be finished only by slow keying or touch control, and deemed as crucial factors for logging by hijackers. On the other hand, many users may store their accounts and passwords in PCs or mobile phones, increasing the vulnerability of being stolen by the hijackers. Hence, there is still much room for improvement of conventional anti-logging encryption computer products.

On the other hand, smart phones and tablet computers also enable on-line transactions via networking with input interface such as soft keyboard for touch screen control. With the growing popularity of smart phones and tablet computers, various kinds of malicious software are used to attack them in the lack of protection of the users input data (especially the accounts, passwords and credit card numbers) from the soft keyboards. Notwithstanding the functions of touch control screen chips could be modified to realize safe inputs of hardware, it is difficult to widely apply this new technology since the touch control screen manufacturers are reluctant to increase their chip cost in absence of numerous market demands. For these reasons, other peripherals shall be incorporated into existing smart phones and tablet computers.

Furthermore, there are currently available with USB-based data storage devices (i.e.: USB thumb drivers, or USB walking drivers). Some manufacturers also fabricate them into a key-shaped pattern, allowing the users to place them together with keys. Although USB walking drivers could also store common accounts and passwords for portable data transmission, such USB walking drivers are only suitable for PCs, not for smart phones and tablet computers, due to the compatibility of hardware and software. Besides, it is technically impossible to directly modify USB walking drivers into audio interfaces, owing to the fact that the signal speed of audio interfaces is very slow and their power supply is extremely limited, without mentioning too high power consumption of USB walking drivers. Another problem is that a USB interface cannot be directly used with the iPhone and iPad of Apple Corp., so different design techniques are required to store digital data via audio interface.

Given a growing number of malicious software against smart phones and tablet computers, the general public would prefer to store accounts, passwords and credit card numbers, etc. into the storage space or cloud space of smart phones and tablet computers, and such important personal data are exposed to certain risks, so it is a crucial issue to develop an innovative product with greater convenience and security.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the innovative technical characteristics of the cloud key device disclosed in the present invention, the users' accounts and passwords could be carried easily without the problem of interface technology, and also applied to smart phones and tablet computers or cloud products only when the cloud key device is inserted into the audio jack to read the accounts and passwords safely and easily for the benefit of the consumers.

Although the invention has been explained in relation to its preferred embodiment, it is to be understood that many other possible modifications and variations can be made without departing from the spirit and scope of the invention as hereinafter claimed.

BRIEF DESCRIPTION OF THE SEVERAL VIEWS OF THE DRAWINGS

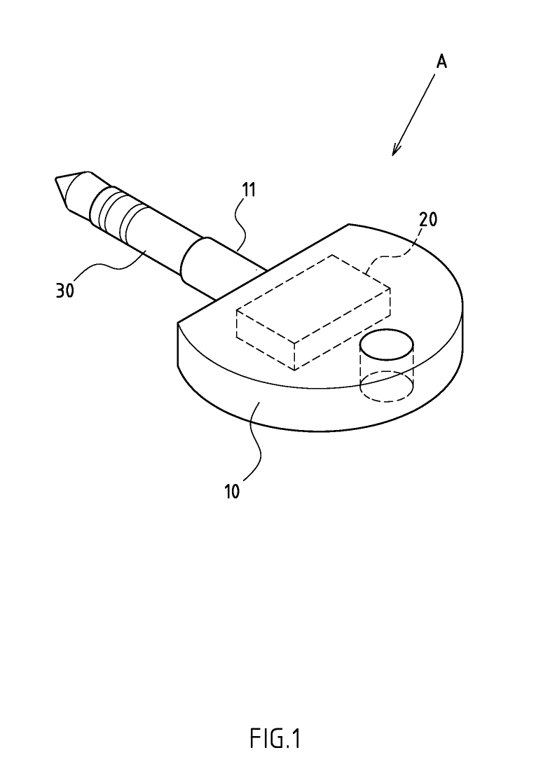

FIG. 1 is a perspective view of a preferred embodiment of the cloud key device of the present invention.

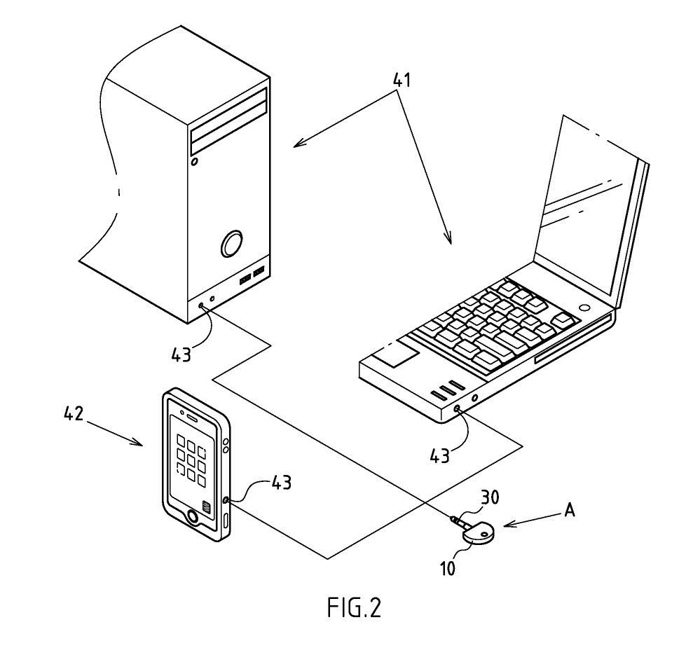

FIG. 2 is a schematic view of the present invention wherein the cloud, key device could be connected with existing, computers and telecom devices.

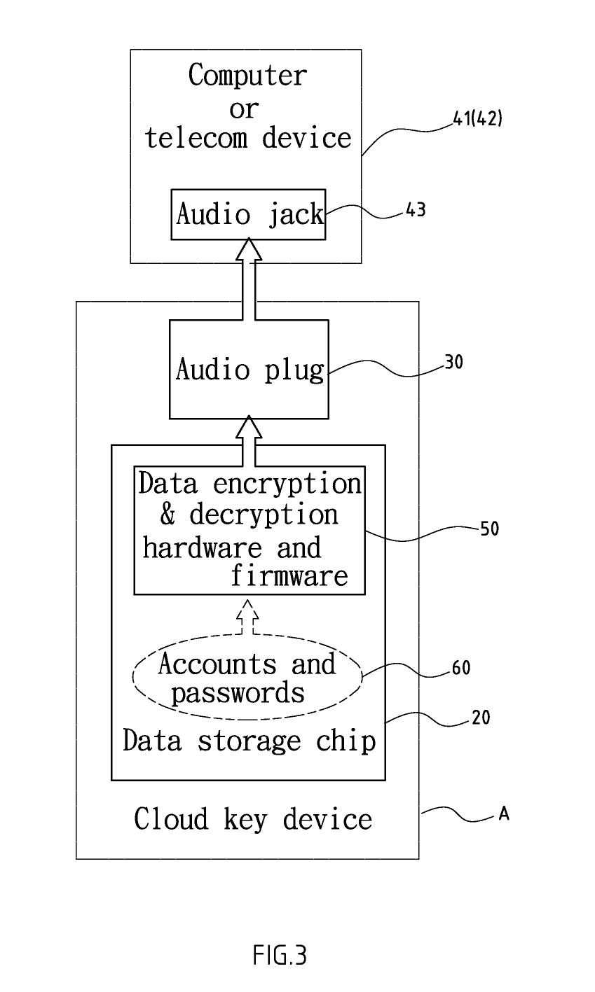

FIG. 3 is a block chart of the present invention showing the connecting relationship among unit components of the cloud key device.

### DETAILED DESCRIPTION OF THE INVENTION

FIGS. 1-3 depict preferred embodiments of as cloud key device of the present invention for data transmission via audio interface, which, however, are provided for only explanatory objective for patent claims.

Said cloud key device A comprises a portable device body 10, designed with a 3D pattern convenient to carry by the users, and also provided with a data transmission end 11.

A data storage chip 20 is set into the portable device body 10 to store the accounts and passwords set by the users.

An audio plug 30, designed into a standard male audio plug, is protruded from the data transmission end 11 of the portable device body 10, and electrically connected with the data storage chip 20, such that the accounts and passwords stored in the data storage chip could be transmitted via said audio plug 30.

With this cloud key device A, the accounts and passwords of the users could be carried conveniently. Referring to FIG. 2 said audio plug 30 allows to transmit data by connecting with the standard audio jack 43 of existing computers 41 and telecom devices 42 (e.g.: mobile phones and tablet computers) (note: said audio jack is of a transmission interface commonly used by almost all computers and telecom devices), so the users' accounts and passwords could be directly transmitted to the computers 41 or telecom devices 42, thus saying the time-consuming procedures of manual keying or input of accounts and passwords via touch control, and preventing possible neglect of accounts and passwords for simpler, quicker and easier input. Meanwhile, this could alleviate greatly the probability and risks of logging by hijackers. On the other hand, as the users' accounts and passwords are stored in the portable cloud key device A that could be removed, immediately upon utilization, it is not required to store the accounts and passwords in the computers or telecom devices, thus efficiently preventing the theft or attack by hijackers. To sum up, the cloud key device A of the present invention enables to prevent logging and protect accounts and passwords in addition to its technical features including easier convenience in operation.

Referring to FIG. 1, the portable device body 10 and audio plug 30 could be incorporated into a keying pattern. With this design, a preferred embodiment complying with the desired functions of the present invention could be provided, enabling the Users to carry the cloud, key device A of the present invention with optimum convenience and practicability.

Referring to FIG. 3, either the data storage chip 20, computer 41 or telecom device 42 of the cloud key device A could store a data encryption and decryption hardware and firmware 50. When the audio plug 30 is connected to the audio jack 43 of the computer 41 or telecom device 42, said data encryption & decryption hardware and firmware 50 can be triggered to implement encryption & decryption of accounts and passwords 60. In addition to data access functions, it can also prevent the hijackers from logging and attacking. In this preferred embodiment, said data encryption & decryption hardware and firmware 50 could be installed additionally to further improve the anti-logging efficacy of the cloud key device A of the present invention.

I claim:

1. A cloud key device for data transmission via audio interface, which comprising:
a portable device body, designed with a 3D pattern convenient to carry by the users, and also provided with a data transmission end;
a data storage chip set into the portable device body to store the accounts and passwords set by the users;
an audio plug, designed into a standard male audio plug, protruded from the data transmission end of the portable device body, and electrically connected with the data storage chip, such that the accounts and passwords stored in the data storage chip could be transmitted via said audio plug;
with this cloud key device, the accounts and passwords of the users could be carried conveniently, and said audio plug allows to transmit data b connecting with the standard audio jack of existing computers and telecom devices, so the users' accounts and passwords could be directly transmitted to the computers or telecom devices, thus preventing logging by non-keying means.

2. The device defined in claim 1, wherein said portable device body and audio plug could be incorporated into a keying pattern.

3. The device defined in claim 2, wherein either the data storage chip, computer or telecom deice of the cloud key device could store a data encryption & decryption hardware and firmware; when the audio plug is connected to the audio jack of the computer or telecom device, said data encryption & decryption hardware and firmware can be triggered to implement encryption & decryption of accounts and passwords.
